(19) United States
(12) Patent Application Publication
(10) Pub. No.: US 2022/0284479 A1
(43) Pub. Date: Sep. 8, 2022

(54) INFORMATION DISPLAY APPARATUS AND METHOD FOR SOCIAL APPLICATION, DISPLAY TERMINAL, AND MEDIUM

(71) Applicant: BIGO TECHNOLOGY PTE. LTD., Singapore (SG)

(72) Inventors: Xiao SUN, Guangzhou (CN); Siying CHEN, Guangzhou (CN); Tiejun WANG, Guangzhou (CN)

(21) Appl. No.: 17/631,342

(22) PCT Filed: Jun. 24, 2020
(86) PCT No.: PCT/CN2020/098111

§ 371 Date: Jan. 28, 2022

(30) Foreign Application Priority Data
Jul. 31, 2019 (CN) 201910705120.4

(51) Int. Cl. G06Q 30/02; G06F 16/9536; G06Q 50/00

(52) U.S. Cl. CPC G06Q 30/0269; G06F 16/9536; G06Q 50/01

(57) ABSTRACT

Provided is an information display apparatus for a social application, including a first information stream page and a second information stream page, wherein the first information stream page is configured to display posts published by first objects, the first objects including a user who has a first-type relationship with a current user, the second information stream page is configured to display posts published by second objects, the second objects including a user, in a group that the current user joins, who has a second-type relationship with the current user, and a portal of the second information stream page is displayed on the first information stream page in response to the posts published by the second objects being updated; wherein the first-type relationship is a friend relationship, and the second-type relationship is a non-friend relationship.

### CROSS-REFERENCE TO RELATED APPLICATION

This application is a U.S. national stage of international application No. PCT/CN2020/098111, filed on Jun. 24, 2020, which claims priority to Chinese Patent Application No. 201910705120.4, filed on Jul. 31, 2019, the disclosures of which are incorporated herein by reference in their entireties.

### TECHNICAL FIELD

Embodiments of the present application relate to the field of data push, and in particular, to an information display apparatus and method for a social application, a display terminal, and a medium.

### BACKGROUND

As Internet technologies rapidly develop, a growing number of users choose to publish text, images, or videos through various social software to express their ideas. In this case, to better view information published by others, social software is provided with corresponding post space as a display interface, such as Moments of WeChat, or a home page of Sina Weibo or Twitter, to display the information published by others and facilitate browsing, viewing, or following for a current user.

### SUMMARY

Embodiments of the present application provide an information display apparatus and method for a social application, a display terminal, and a medium to implement the separate display of posts published by different types of users, effectively improve self-selection space for interacting with different types of users, and help reduce redundancy of pushed information.

An embodiment of the present application provides an information display apparatus for a social application. The apparatus includes a first information stream page and a second information stream page. Wherein the first information stream page is configured to display posts published by first objects, the first objects including a user who has a first-type relationship with a current user; and the second information stream page is configured to display posts published by second objects, the second objects including a user, in a group that the current user joins, who has a second-type relationship with the current user. A portal of the second information stream page is displayed on the first information stream page in response to the posts published by the second objects being updated.

An embodiment of the present application provides an information display method for a social application. The method includes the following steps that can be performed in any order:
displaying posts published by first objects on a first information stream page, wherein the first objects include a user who has a friend relationship with a current user; and
displaying posts published by second objects on a second information stream page corresponding to a group that the current user joins, wherein the second objects include a user, in the group that the current user joins, who has a non-friend relationship with the current user; wherein
a portal of the second information stream page is displayed on the first information stream page in response to the posts published by the second objects being updated.

An embodiment of the present application provides a display terminal. The display terminal includes:
one or more processors; and
a storage apparatus, configured to store one or more programs; wherein
wherein the at least one processor, when running the one or more programs, is caused to perform the information display method for a social application described in any embodiment of the present application, or wherein the display terminal is provided with the information display apparatus for a social application described in any embodiment of the present application.

An embodiment of the present application provides an information display system. The system includes a publishing terminal, a server, and the display terminal described in any embodiment of the present application.

The publishing terminal is configured to upload corresponding published posts to the server. The server is configured to find a user who has a friend relationship with a publishing user corresponding to the published post and a user, in a group that the publishing user joins, who has a non-friend relationship with the publishing user, and send the published post and a relationship between a display user of the display terminal and the publishing user to the display terminal of the user who has the friend relationship with the publishing user and the display terminal of the user who has the non-friend relationship with the publishing user.

An embodiment of the present application provides a computer-readable storage medium, storing at least one computer program. Wherein the at least one program, when run by a processor, causes the processor to perform the information display method for a social application described in any embodiment of the present application.

### BRIEF DESCRIPTION OF THE DRAWINGS

FIG. 1 is an architectural diagram of an application scenario to which an information display method for a social application is applicable according to some embodiments of the present application;

FIG. 2 is a schematic diagram of an interface of a social application in an information display apparatus for a social application according to Embodiment 1 of the present application;

FIG. 3 is a schematic diagram of an interface of a social application in an information display apparatus for a social application according to Embodiment 2 of the present application; FIG. 4A is a flowchart of an information display method for a social application according to Embodiment 3 of the present application;

FIG. 4B is a schematic diagram of a principle of an information display method for a social application according to Embodiment 3 of the present application;

FIG. 5 is a flowchart of an information display method for a social application according to Embodiment 4 of the present application;

FIG. 6 is a schematic structural diagram of an information display system according to Embodiment 5 of the present application; and

FIG. 7 is a schematic structural diagram of a display terminal according to Embodiment 6 of the present application.

### DETAILED DESCRIPTION

The following describes the present application with reference to the accompanying drawings and embodiments. The embodiments described herein are merely intended to explain the present application, rather than to limit the present application. For ease of description, only some structures rather than all structures related to the present application are shown in the accompanying drawings.

In the related art, post space in a social application mainly displays information published by friends of the current user to meet requirements of daily interaction between the friends and the current user. To further enhance social activeness between users or for specific business goals, some social applications also push some additional information, such as information published by non-friend users or advertisements based on a predetermined recommendation model. However, in the foregoing solution of the related art, if the user wants to interact with more non-friends, recommendation results are mainly relied on, and self-selection is difficult. In addition, that the information is pushed based on the recommendation model is usually as follows: a backend selects non-friend users in which the current user may be interested by a corresponding push algorithm, and then pushes information published by the non-friend users to the current user; in the case that the push algorithm is inaccurate, information published by non-friend users in which the current user is not interested may be displayed in a push page. This is prone to the redundancy of pushed information.

In the embodiments, a new display solution for posts published by different types of users is designed in a social application, to implement a separate display of the posts published by different types of users. When a user who has a second-type relationship with a current user and is in a same group that the current user joins, it indicates that the user and the current user both are interested in information of the group. In this this case, posts published by the users who have the second-type relationship with the current user, and are in the same group as that the current user joins are displayed, and posts published by other users who have the second-type relationship with the current user but currently are not in the same group with the current user are excluded. This is equivalent to determining whether the current user and the user who has the second-type relationship with the current user are in the same group such that the current user can independently select posts of interest published by different types of users, thereby reducing redundancy of pushed information. In addition, the current user can view the posts published by different types of users on a first information stream page and a second information stream page to interact well with different types of users, which effectively improves self-selection space for interacting with different types of users, thereby improving a social scope of the current user.

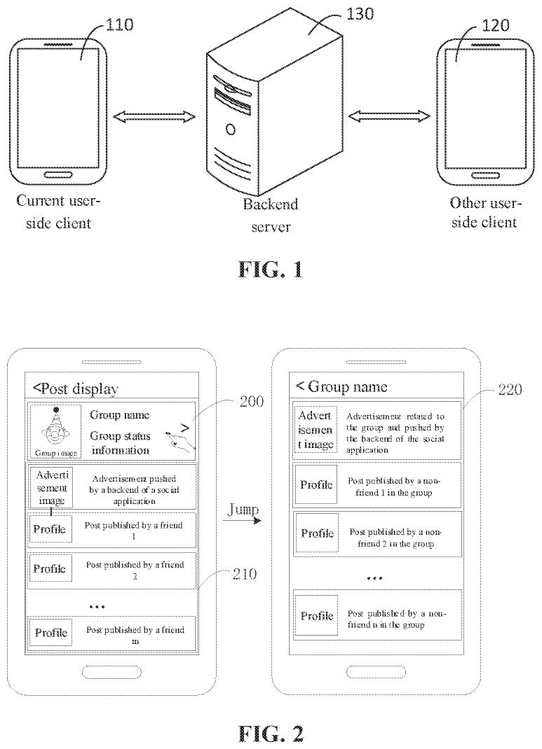

FIG. 1 is an architectural diagram of an application scenario to which an information display method for a social application is applicable according to some embodiments of the present application. Referring to FIG. 1, the application scenario may include a current user-side client 110, other user-side clients 120, and a backend server 130.

The current user-side client 110 is a user terminal of a current user who receives a post published by another user, and the other user-side clients 120 may comprise user terminals of a user who has a first-type relationship with the current user and a user who has a second-type relationship with the current user in a group that the current user joins, among other users who publish posts at a current moment. In this case, the current user-side client 110 and other user-side clients 120 are configured with social applications for displaying posts published by corresponding users, which implements separate display of posts published by different types of users. The backend server 130 is a server for configuring and storing relevant post information corresponding to the social application used to display posts published by users in the embodiments of the present application. The backend server 130 serves as an intermediate terminal between the current user-side client 110 and other user-side clients 120 when the posts published by different types of users are displayed, and can forward published posts between the current user and the user who has the first-type relationship with the current user and/or the user who has the second-type relationship with the current user and is in the group that the current user joins, to implement a separate display of posts published by different types of users.

When the posts published by different types of users are displayed on the current user side, the two types of display pages of a first information stream page and a second information stream page are preset. The first information stream page is configured to display posts published by first objects, and the first objects include the user who has the first-type relationship with the current user. The second information stream page is configured to display posts published by second objects, and the second objects include the user who is in the group that the current user joins and has the second-type relationship with the current user. In addition, a portal of the second information stream page is displayed on the first information stream page in response to the posts published by the second objects being updated, such that overall information of the second information stream page can be set on the first information stream page, to separately display the posts published by different types of users. In the case that the first-type relationship is a friend relationship and the second-type relationship is a non-friend relationship, in addition to displaying posts of friends of the current user, it is determined whether to display a post published by the non-friend user of the current user by determining whether the current user and the non-friend user are in the same group. This is equivalent to that the current user actively selects posts of interest published by different types of users. This prevents drawbacks of displaying only posts published by friends or displaying all posts published by non-friends, and reduces redundancy of pushed information.

For example, the current user serves as a post publisher. The current user-side client 110 sends a post published by the current user to the backend server 130. In this case, the backend server 130 selects users who have the friend relationship with the current user and users, in the group that the current user joins, who have the non-friend relationship with the current user from all users registered in the social application, to forward the post published by the current user to the other user-side clients 120 of friends of the current user and non-friends who is in the group that the current user joins, to make the other user-side clients 120 serve as the post displayer. The post published by the current user is displayed on the first information stream page or the second information stream page for different other user-side terminal 120 based on a relationship between the current user and the post displayer. This implements separate display of the post published by the current user on the friend side and the non-friend side in the group and improves the accuracy of information display.

In this embodiment, operations of displaying the posts published by different types of users in the social applications corresponding to the current user-side client 110, other user-side clients 120, and the backend server 130 are described in the following embodiments, and are not described herein. In the embodiments of the present application, the number of other user-side clients 120 is determined based on a total number of users who have the first-type relationship with the current user and a total number of users who are in the group that the current user joins, and have the second-type relationship with the current user. This is not limited.

Embodiment 1

FIG. 2 is a schematic diagram of an interface of a social application in an information display apparatus for a social application according to Embodiment 1 of the present application. This embodiment is suitable for displaying posts published by different types of users. Referring to FIG. 2, the information display apparatus for a social application in this embodiment may include a first information stream page 210 and a second information stream page 220.

The first information stream page 210 is configured to display posts published by first objects, and the first objects include users who have a first-type relationship with a current user. The second information stream page 220 is configured to display posts published by second objects, and the second objects include users who are in a group that the current user joins and have a second-type relationship with the current user. A portal 200 of the second information stream page 220 is displayed on the first information stream page 210 in response to the posts published by the second objects being updated.

In this embodiment, to prevent drawbacks that only posts published by friends are displayed or all posts published by non-friends are displayed, the posts published by the users who have the first-type relationship with the current user and the posts published by the users who are in the group that the current user joins and have the second-type relationship with the current user are separately displayed. This implements a separate display of the posts published by different types of users and improves the accuracy of information display. The group in this embodiment may be any social group that a plurality of users join, such as a chat group that a plurality of users (friends and non-friends) join to facilitate conversations between the plurality of users or a topic group established for a topic of interest. For example, the current user serves as a post displayer. When viewing posts published by related users, the current user first triggers a corresponding post display control, such as a portal of Moments in

WeChat, to go to a preset post display page. In this embodiment, a home page that is used to display the posts published by different types of users and appears for the first time in response to the current user performing the trigger operation is set as the first information stream page 210 for displaying the posts published by the first objects including the users who have the first-type relationship with the current user. The second information stream page 220 is set as a next-level page of the first information stream page 210 for displaying the posts published by the second objects including the users who have the second-type relationship with the current user and are in the group that the current user joins. In this case, in response to the posts published by the second objects being updated, the portal 200 of the second information stream page 220 is provided on the first information stream page 210 for going to the second information stream page 220 with the trigger of the current user. For example, the portal 200 of the second information stream page 220 may be a virtual key provided at a fixed position on the first information stream page 210 for going to the second information stream page 220 in response to detecting a trigger operation performed by the current user on the virtual key. Alternatively, a portal bar with a trigger style similar to display styles of the posts displayed on the first information stream page 210 is provided on the first information stream page 210 together with the posts published by the first objects.

For example, the portal 200 of the second information stream page 220 in this embodiment is displayed on the first information stream page 210 in a form of a post group bar, as shown in FIG. 2. With a display style similar to those of the posts published by the friends and displayed on the first information stream page 210, the post group bar is used for centralized summarization of the posts published by the second objects and displayed on the second information stream page 220. In this case, because the posts published by the first objects and the post group bar formed by the portal 200 of the second information stream page 220 are displayed on the first information stream page 210, for standardized management and orderly display of the first information stream page 210, a display order of the post group bar and the posts published by the first objects may be set in this embodiment. In this embodiment, the post group bar formed by the portal 200 of the second information stream page 220 and the posts published by the first objects may be sequentially arranged on the first information stream page 210 based on publishing time of a plurality of posts. For example, the post group bar formed by the portal 200 of the second information stream page 220 and the posts published by the first objects are sequentially displayed on the first information stream page 210 based on publishing time of a latest post displayed on the second information stream page 220 and a plurality of posts displayed on the first information stream page 210.

To accurately distinguish the portal 200 of the second information stream page 220 displayed on the first information stream page 210, as shown in FIG. 2, the portal 200 of the second information stream page 220 in this embodiment is displayed in the form of the post group bar on the first information stream page 210. At least one of a name of the group, an image of the group, and status information of the group is displayed on the post group bar for indicating the group to which the posts published by the non-friends and displayed on the second information stream page 220 corresponding to the portal 200 belong. In this way, related attributes of the posts published by the non-friends and displayed on the second information stream page 220 corresponding to the portal 200 can be analyzed based on group information displayed on the post group bar.

In this embodiment, the first-type relationship is a friend relationship, and the second-type relationship is a non-friend relationship. In this case, the first information stream page 210 is configured to display the posts published by the first objects including the users who have the friend relationship with the current user, and the second information stream page 220 is configured to display the posts published by the second objects including the users who are in the group that the current user joins and have the non-friend relationship with the current user, such that the posts published by the friends of the current user and the non-friends separately displayed.

In addition, to improve the diversity of information displayed on the first information stream page 210 and the second information stream page 220, the posts published by the first objects in this embodiment may further include posts published by users who have the second-type relationship with the current user and pushed by a backend of the social application and/or advertisements pushed by the backend of the social application. In this case, the backend of the social application may, by a corresponding recommendation algorithm, actively select users who are associated and have the non-friend relationship with the current user, such as non-friends within a preset distance from the current user, and posts published by the non-friends and actively pushed by the backend of the social application by using the preset recommendation algorithm are displayed on the first information stream page 210; and/or advertisements actively pushed by the backend of the social application by the preset recommendation algorithm are displayed on the first information stream page 210. In this case, the first objects in this embodiment may include the friends of the current user, the non-friends of the current user pushed by the backend of the social application, and/or advertisement publishers pushed by the backend of the social application. The posts published by the second objects may further include an advertisement related to the group corresponding to the second information stream page 220 and pushed by the backend of the social application. For example, if the group is related to photography, the backend of the social application actively obtains a photography-related advertisement by the preset recommendation algorithm, and the photography-related advertisement actively pushed by the backend of the social application is displayed on the second information stream page 220.

To ensure accuracy of the posts published by the users on the first information stream page 210 and the second information stream page 220, with respect to the posts published by the users who have the second-type relationship with the current user, pushed by the backend of the social application, included in the posts published by the first objects and displayed on the first information stream page 210, the users who have the second-type relationship with the current user are not the users who have the second-type relationship with the current user in the group that the current user joins included in the second objects that publish the posts displayed on the second information stream page 220. In other words, the non-friends of the current user included in the first objects corresponding to the first information stream page 210 and the current user do not both join any group, and both are non-friends who do not both join the same group.

To distinguish the posts published by non-friends in different groups that the current user joins, different second information stream pages 220 are set to correspond to the different groups in this embodiment such that when the current user receives posts published by different users who are in the different groups that the current user joins, and have the non-friend relationship with the current user, it indicates that the posts published by the second objects corresponding to the different groups are updated. Therefore, different portals 200 of the second information stream pages 220 corresponding to the different groups that the current user joins are displayed on the first information stream page 210. In this case, the portals 200 of the different second information stream pages 220 may be set based on group information of the groups corresponding to the second information stream pages 220, and posts published by a plurality of non-friends of the current user in the different groups are correspondingly displayed on the second information stream pages 220 corresponding to the groups. For example, the current user and a non-friend 1 are both in a photography-related group, and the current user and a non-friend 2 are both in a food-related group. In this case, a post published by the non-friend 1 is displayed on a second information stream page corresponding to the photography-related group, and a post published by the non-friend 2 is displayed on a second information stream page corresponding to the food-related group, to distinguish the posts published by the non-friends in the different groups.

Because the current user may join a new group as needed, in the case that the current user receives posts published by non-friends in the new group, a portal 200 of a new second information stream page 220 is inserted on the first information stream page 210. In this case, the new second information stream page 220 is used to display the posts published by the non-friends in the new group.

In the technical solution provided in this embodiment, the first information stream page and the second information stream page are preset, wherein the first information stream page is configured to display the posts published by the first objects including the users who have the first-type relationship with the current user, and the second information stream page is configured to display the posts published by the second objects including the users who are in the group that the current user joins and have the second-type relationship with the current user. This implements the separate display of the posts published by different types of users. The posts published by different types of users can be accurately selected, and centralized management can be performed on the posts published by different types of users. This also prevents drawbacks of prior art that display only the posts of the friends or display posts published by users in which the current user may be interested and that are determined by a preset push algorithm. In addition, the users who have the second-type relationship with the current user on the second information stream page are in the same group as the current user, which indicates that both users are interested in the information of the group. In this case, the posts published by the users who have the second-type relationship with and are in the same group as the current user are displayed in a centralized manner, and posts published by other users who have the second-type relationship with the current user are excluded. This helps reduce the redundancy of pushed information. In addition, the current user can view the posts published by different types of users on the first information stream page and the second information stream page to interact well with different types of users, which effectively improves self-selection space for the current user to interact with different types of users, thereby improving a social scope of the current user.

Embodiment 2

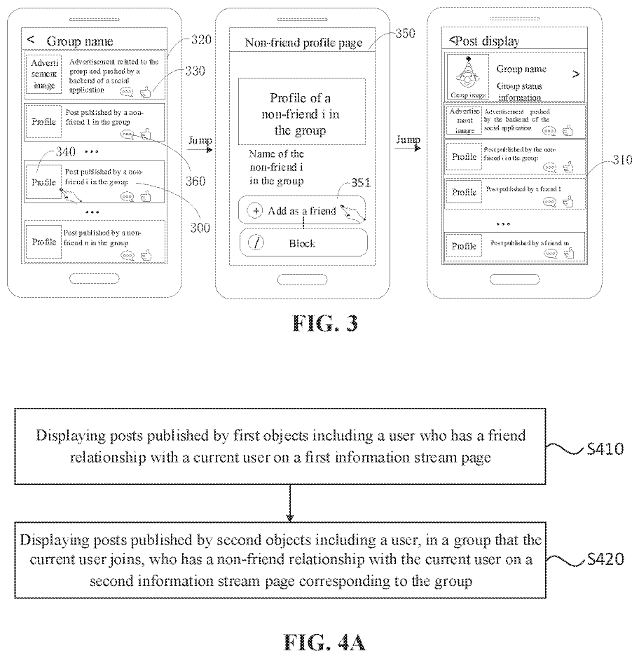

FIG. 3 is a schematic diagram of an interface of a social application in an information display apparatus for a social application according to Embodiment 2 of the present application. This embodiment is described based on the foregoing embodiment. This embodiment mainly describes a relationship between a first information stream page and a second information stream page in the application and information configured for displayed posts.

Optionally, referring to FIG. 3, to perform corresponding operations on a plurality of posts displayed on a first information stream page 310 and a second information stream page 320, each post displayed on the first information stream page 310 and the second information stream page 320 is configured with a like control 330 and/or a comment control 360 in this embodiment. A current user can trigger the like control 330 and/or the comment control 360 configured for each post displayed on the first information stream page 310 and the second information stream page 320 to like the post and/or enter a comment such that the current user can give an opinion on the post. Likes and/or comments of plurality posts displayed on the first information stream page 310 and the second information stream page 320 are visible to the current user such that the current user can observe other users' opinions on the plurality of posts.

In addition, the current user may add a user, in a group that the current user joins, who has a non-friend relationship with the current user and is included in the second objects as a friend when viewing posts published by second objects and displayed on the second information stream page 320. Therefore, to ensure accuracy of the posts published by users and displayed on the first information stream page 310 and the second information stream page 320, in this embodiment, in the case that the current user adds the user, in the group that the current user joins, who has a second-type relationship (the non-friend relationship) with the current user as the friend, a post published by the user is removed from the second information stream page 320 and displayed on the first information stream page 310.

Optionally, a portal 340 for the current user to add the user as the friend is configured for the post published by the user who has the second-type relationship (non-friend relationship) with the current user and displayed on the second information stream page 320 in this embodiment. The current user goes to the second information stream page 320 by tapping a portal 300 of the second information stream page 320 displayed on the first information stream page 310; and determines whether the non-friend in the group needs to be added as the friend by viewing the post published by the user who has the non-friend relationship with the current user in the corresponding group on the second information stream page 320. In the case that the current user needs to add the non-friend in the group as the friend, the current user triggers the portal 340 for the post published by the non-friend and for the current user to add the user as the friend to go to a profile page 350 of the non-friend, as shown in FIG. 3. The profile page 350 of the non-friend is provided with a friend addition prompt 351. The current user triggers the friend addition prompt 351 to send a friend verification request to the non-friend. After the non-friend passes the verification, the current user adds the non-friend as the friend. In this case, the post published by the non-friend and previously displayed on the second information stream page 320 is removed from the second information stream page 320 and displayed on the first information stream page 310.

In the technical solution provided in this embodiment, the first information stream page and the second information stream page are preset, wherein the first information stream page is configured to display posts published by first objects including users who have a first-type relationship with the current user, and the second information stream page is configured to display the posts published by the second objects including the users who are in the group that the current user joins and have the second-type relationship with the current user. This implements separate display of posts published by different types of users. The posts published by the friends of the current user and the non-friends in the group that the current user joins can be accurately selected, and centralized management can be performed on the posts published by different types of users. This also prevents defects of displaying only the posts of the friends or displaying posts published by users in which the current user may be interested and that are determined by a preset push algorithm in the related art. When non-friends in the group that the current user joins are in the same group as the current user, it indicates that the non-friends and the current user are interested in information of the group. In this case, the posts published by the non-friends in the group that the current user joins are displayed, and posts published by other non-friends are excluded. This improves the accuracy of information display and reduces redundancy of pushed information. In addition, the current user can view the posts published by the non-friends in the corresponding group on the second information stream page to interact well with the non-friends, which effectively improves self-selection space for the current user to interact with the non-friends, thereby improving a social scope of the current user.

Embodiment 3

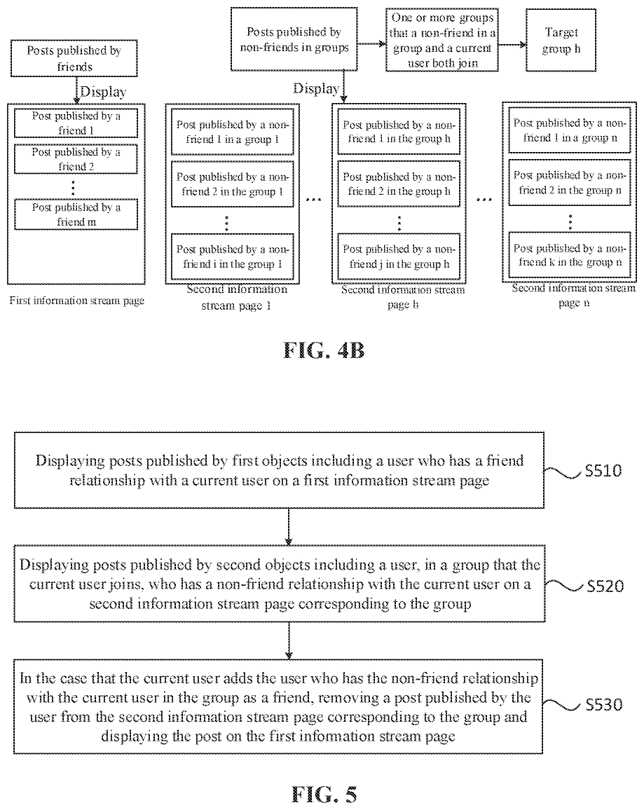

FIG. 4A is a flowchart of an information display method for a social application according to Embodiment 3 of the present application. FIG. 4B is a schematic diagram of a principle of an information display process for a social application according to Embodiment 3 of the present application. This embodiment is suitable for displaying posts published by different types of users. The information display method provided in this embodiment may be executed by a display terminal provided in the embodiments of the present application. The display terminal may be any user terminal configured with a social application for displaying posts published by users, such as a mobile phone, a tablet computer, or a palmtop computer.

As shown in FIG. 4A, the method may include the following steps that can be performed in any order:

In step S410, posts published by first objects including a user who has a friend relationship with a current user are displayed on a first information stream page.

To improve the comprehensiveness of post display, in this embodiment, in addition to displaying posts published by friends of the current user, posts published by non-friends of the current user are selectively displayed. Therefore, when a post published by a user is received, a relationship between the user and the current user first needs to be determined. In this case, when receiving the post published by the user, a backend server first finds corresponding friends in a pre-established friend database and non-friends in a same group in a joined group database, and then forwards the post published by the user and the relationship between the user and the user of the display terminal to the corresponding display terminal. In addition, the first objects in this embodiment are information publishing objects displayed on the first information stream page, and may include the users who have the friend relationship with the current user and users who have a non-friend relationship with the current user and are pushed by a backend of the social application. For example, when the user terminal of the current user serves as the display terminal, a relationship between the current user and another user who publishes a post sent by the backend server can be directly obtained by parsing the post. Posts published by the users who have the friend relationship with the current user are displayed on the preset first information stream page to facilitate centralized management of the posts published by friends.

To ensure comprehensiveness of the first objects corresponding to the first information stream page, when the posts published by the first objects are displayed on the first information stream page, the method in this embodiment may further include: displaying posts published by the users who have the non-friend relationship with the current user and pushed by the backend of the social application and/or an advertisement pushed by the backend of the social application.

The backend of the social application may use a corresponding recommendation algorithm to actively select users who are associated and have the non-friend relationship with the current user, such as non-friends within a preset distance from the current user, and posts published by the non-friends and actively pushed by the backend of the social application by using the preset recommendation algorithm are displayed on the first information stream page. In this case, the users who have the non-friend relationship with the current user and are pushed by the backend of the social application are not users who are in a group that the current user joins and have the non-friend relationship with the current user and are included in second objects corresponding to a second information stream page. In other words, the users who have the non-friend relationship with the current user and are pushed by the backend of the social application on the first information stream page may be non-friends who do not join any group together with the current user. The advertisement actively pushed by the backend of the social application by using the preset recommendation algorithm may be displayed on the first information stream page. Therefore, the first objects corresponding to the first information stream page in this embodiment may include any one or more friends of the current user, the non-friends of the current user pushed by the backend of the social application, and advertisement publishers pushed by the backend of the social application.

In step S420, posts published by second objects including a user who is in a group that the current user joins, and has a non-friend relationship with the current user are displayed on a second information stream page corresponding to the group.

A portal of the second information stream page is displayed on the first information stream page in response to the posts published by the second objects being updated. Because the current user may join a plurality of groups, different groups that the current user joins may correspond to a plurality of different second information stream pages. In other words, when the posts sent by the second objects in the different groups are updated, portals of the plurality of second information stream pages corresponding to the different groups may be displayed on the first information stream page.

If the current user receives a post published by a user who is in the group that the current user joins and has the non-friend relationship with the current user, a group that the non-friend and the current user both join is first determined to display the post published by the non-friend on a second information stream page corresponding to the group. In this case, the current user triggers a portal of the second information stream page corresponding to the group on the first information stream page to go to the second information stream page and then views the post published by the non-friend in the group on the second information stream page.

For example, in the case that a correlation between the current user and the non-friend in the group that the current user joins is relatively high, the current user and the non-friend may be both in a plurality of groups. Therefore, to increase the accuracy of the posts published by non-friends of the current user and displayed on the second information stream page, the displaying the posts published by the second objects including the user who has the non-friend relationship with the current user and in the group that the current user joins on the second information stream page corresponding to the group in this embodiment may include: determining a target group that the current user and the user who has the non-friend relationship with the current user both join; and displaying the post published by the user who has the non-friend relationship with the current user on the second information stream page corresponding to the target group.

When a post published by a non-friend in the group that the current user joins is received, groups that the non-friend and the current user both join are first determined, and a corresponding target group is selected based on a correlation between the user who has the non-friend relationship with the current user and the current user in different groups such that the post published by the user who has the non-friend relationship with the current user in the group that the current user joins are displayed only on the second information stream page corresponding to the target group. For example, the determining the target group that the current user and the user who has the non-friend relationship with the current user both join in this embodiment may include: determining one or more groups that the current user and the user who has the non-friend relationship with the current user both join; and in the case that the number of groups is one, determining the group as the target group; or in the case that the number of groups is more than one, determined a group with a highest degree of interaction between the current user and the user who has the non-friend relationship with the current user in different groups as the target group.

When a post published by a user who is in the group that the current user joins and who has the non-friend relationship with the current user is received, the number of groups that the user who has the non-friend relationship with the current user and the current user both joins is first determined. If the non-friend and the current user both join only one group, this group is regarded as the target group in this embodiment; or if the non-friend and the current user both join a plurality of groups, degrees of interaction of the plurality of different groups that the non-friend and the current user both join are determined, and a group with a highest degree of interaction is selected as the target group in this embodiment. In other words, a correlation between the non-friend and the current user in the target group is highest. Therefore, the post published by the non-friend is displayed only on a second information stream page corresponding to the target group.

The current user may selectively add a non-friend as a friend as needed by viewing a post published by a user who has the non-friend relationship with the current user and displayed on the second information stream page, and then interact well with the non-friend in the group that the current user joins to expand a corresponding social scope.

In addition, to ensure comprehensiveness of the second objects corresponding to the second information stream page, when the posts published by the first objects are displayed on the first information stream page, the method in this embodiment may further include: an advertisement related to the group that the current user joins and pushed by the backend of the social application are displayed on the second information stream page corresponding to the group.

The second objects corresponding to the second information stream page may not only include the user who has the non-friend relationship with the current user in the group that the current user joins, but also include an advertisement publisher related to the group corresponding to the second information stream page and pushed by the backend of the social application such that an advertisement related to the group that the current user joins and actively pushed by the backend of the social application by using the preset recommendation algorithm is displayed on the second information stream page corresponding to the group. For example, if the group that the current user joins is related to photography, the backend of the social application uses the preset recommendation algorithm to actively obtain a photography-related advertisement, and the photography-related advertisement actively pushed by the backend of the social application is displayed on the second information stream page corresponding to the photography-related group.

In the technical solution provided in this embodiment, the first information stream page and the second information stream page are preset, wherein the first information stream page is configured to display the posts published by the first objects including the user who has the friend relationship with the current user, and the second information stream page is configured to display the posts published by the second objects including, in the group that the current user joins, the user who has the non-friend relationship with the current user. This implements separate display of the posts published by different types of users. The posts published by different types of users can be accurately selected, and centralized management can be performed on the posts published by different types of users. This also prevents defects of displaying only the posts of the friends or displaying posts published by users in which the current user may be interested and that are determined by a preset push algorithm in the related art. In addition, the user who has the non-friend relationship with the current user on the second information stream page is in the same group as the current user, which indicates that both users are interested in information of the group. In this case, the posts published by the users who have the non-friend relationship with and are in the same group as the current user are displayed in a centralized manner, and posts published by other users who have the non-friend relationship with the current user are excluded. This helps reduce the redundancy of pushed information. In addition, the current user can view the posts published by different types of users on the first information stream page and the second information stream page to interact well with different types of users, which effectively improves self-selection space for the current user to interact with different types of users, thereby improving a social scope of the current user.

Embodiment 4

FIG. 5 is a flowchart of an information display method for a social application according to Embodiment 4 of the present application. This embodiment is described based on the foregoing embodiments. This embodiment mainly describes a conversion relationship between a first information stream page and a second information stream page for posts published by user and displayed.

Optionally, as shown in FIG. 5, this embodiment may include the following steps:

In S510, posts published by first objects including a user who has a friend relationship with a current user are displayed on a first information stream page.

In S520, posts published by second objects including a user who is in a group that the current user joins and has a non-friend relationship with the current user are displayed on a second information stream page corresponding to the group.

In S530, in the case that the current user adds the user who has the non-friend relationship with the current user in the group as a friend, a post published by the user is removed from the second information stream page corresponding to the group and displayed on the first information stream page.

Because the current user may actively add a non-friend in the group that the current user joins as a friend based on a post published by the non-friend, the post published by the user who has the non-friend relationship with the current user in the group that the current user joins is removed from the second information stream page corresponding to the group and displayed on the first information stream page in the case that the current user adds the user who has the non-friend relationship with the current user in the group as the friend, to ensure accuracy of the posts displayed on the first information stream page and the second information stream page.

For example, in this embodiment, that the current user adds the user who has the non-friend relationship with the current user in the group as the friend may include: a corresponding friend adding operation is performed based on the post published by the user who has the non-friend relationship with the current user in the group and displayed on the second information stream page corresponding to the group. A portal for the current user to add the user as a friend is configured for the post published by the user who has the non-friend relationship with the current user.

In this embodiment, the post published by the user who has the non-friend relationship with the current user and displayed on the second information stream page is configured with the portal for the current user to add the user as the friend. When the current user views the post published by the user who has the non-friend relationship with the current user in the group and displayed on the second information stream page, if the current user wants to add the non-friend as the friend, the current user triggers the portal configured for the post published by the user who has the non-friend relationship with the current user and for the current user to add the user as the friend to go to a profile page of the non-friend, and triggers a corresponding friend addition prompt on the profile page of the non-friend to send a corresponding friend verification request to the non-friend to perform the corresponding friend adding operation. In this way, after the current user adds the user who has the non-friend relationship with the current user as the friend, the post published by the non-friend and displayed on the second information stream page is removed from the second information stream page and displayed on the first information stream page.

The current user may continue to join a new group as needed, and no portal of a second information stream page corresponding to the new group is provided on the first information stream page. Therefore, if the current user receives a post published by a non-friend in the new group, a portal of a new second information stream page is inserted into the first information stream page based on overall attributes of the new group. The new second information stream page corresponds to the new group. Posts published by non-friends in the new group are displayed on the new second information stream page such that the posts published by non-friends in different groups can be separately managed.

In the technical solution provided in this embodiment, after the current user adds the user who has the non-friend relationship with the current user in the group corresponding to the second information stream page as the friend, the post published by the user is removed from the second corresponding to the group and displayed on the first information stream page, to update the posts published by different types of users and separately displayed in real time. The posts published by friends of the current user and non-friends in the group that the current user joins can be accurately selected, and centralized management can be performed on the posts published by different types of users. In addition, the non-friends in the group that the current user joins are in the same group as the current user, which indicates both users are interested in information of the group. In this case, the posts published by the non-friends in the group that the current user joins are displayed, and posts published by other non-friends are excluded. This improves the accuracy of information display and reduces redundancy of pushed information. In addition, after the current user joins the new group, the portal of the new second information stream page is inserted on the first information stream page, and the posts published by the non-friends in the new group are displayed on the new second information stream page. This improves the accuracy of displayed posts published by non-friends in different groups.

Embodiment 5

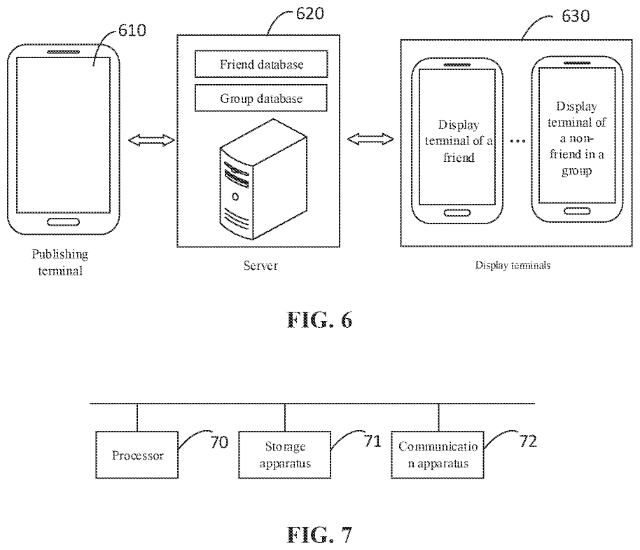

FIG. 6 is a schematic structural diagram of an information display system according to Embodiment 5 of the present application. Referring to FIG. 6, the information display system may include a publishing terminal 610, a server 620, and a display terminal 630 that implements the information display method for a social application provided in the foregoing embodiments.

The publishing terminal 610 is configured to upload corresponding published posts to the server 620. The server 620 is configured to find a user who has a friend relationship with a publishing user corresponding to the published post and a user, in a group that the publishing user joins, who has a non-friend relationship with the publishing user, and send the published post and a relationship between a display user of the display terminal and the publishing user to display terminals 630 of the found users.

The publishing user publishes the corresponding post by the publishing terminal 610. After receiving the published post, the publishing terminal 610 uploads the published post to the server 620 such that the server 620 forwards the post published by the publishing user to the corresponding display terminal 630 for display. In this case, the server 620 finds friends of the publishing user and non-friends in the same group as the publishing user based on identity information of the publishing user, and sends the post published by the publishing user and the relationship between the publishing user and the display user of the corresponding display terminal 630 to the display terminals 630 of the friends and non-friends in the same group such that the display terminal 630 can display the post published by the publishing user on a preset first information stream page or second information stream page based on the relationship between the publishing use and display user, to implement separate display of posts published by different types of users. This improves accuracy of information display. There is no need to display all posts published by non-friends, thereby reducing redundancy of pushed information.

For example, the server 620 may determine the user who has the friend relationship with the publishing user in a friend database of the publishing user, select the group that the publishing user joins in a group database of the publishing use, and determine the user who has the non-friend relationship with the publishing user in the group.

To ensure comprehensiveness of displayed information, the server 620 may be further configured to use a preset recommendation algorithm to actively push a post published by a user who has a non-friend relationship with the display user of the display terminal 630 and/or a corresponding advertisement to the display terminal 630.

In the technical solution provided in this embodiment, the server finds the users who have the friend relationship with the publishing user in the friend database of the publishing user and the users who have the non-friend relationship with the publishing user in the group database of the publishing user to ensure comprehensiveness of the friends of the publishing user and the non-friends in the group that the publishing user joins. In addition, the post published by the publishing user is displayed on the first information stream page of the friend of the publishing user, and the post published by the publishing user is displayed on the second information stream page, of the non-friend in the group that the publishing user joins, corresponding to the group, to implement separate display of posts published by different types of users, perform centralized management of posts published by friends and non-friends, effectively improve self-selection space for the display user of the display terminal to interact with different types of users, and helps reduce redundancy of pushed information.

Embodiment 6

FIG. 7 is a schematic structural diagram of a display terminal according to Embodiment 6 of the present application. As shown in FIG. 7, the display terminal includes a processor 70, a storage apparatus 71, and a communication apparatus 72. There may be one or more processors 70 in the display terminal, and one processor 70 is used as an example in FIG. 7. The processor 70, the storage apparatus 71, and the communication apparatus 72 in the display terminal may be connected through a bus or in other manners. The bus connection is used as an example in FIG. 7.

The storage apparatus 71, as a computer-readable storage medium, may be configured to store software programs, computer-executable programs, and modules, such as program instructions/modules corresponding to the information display method for a social application provided in the embodiments of the present application. The processor 70, when running the software programs, instructions, and modules stored in the storage apparatus 71, is caused to execute various functional applications of the device and data processing, that is, perform the foregoing information display method for a social application.

The storage apparatus 71 may mainly include a program storage area and a data storage area. The program storage area may store an operating system, and an application program required by at least one function. The data storage area may store data created by the terminal, and the like. In addition, the storage apparatus 71 may include a high-speed random access memory (RAM), or may include a non-transitory memory, for example, at least one magnetic disk storage device, a flash memory device, or another non-transitory solid-state storage device. In some embodiments, the storage apparatus 71 may further include memories remotely configured relative to the processor 70, and these remote memories may be connected to the display terminal over a network. Examples of the foregoing network include, but are not limited to, the Internet, an enterprise intranet, a local area network, a mobile communication network, and a combination thereof.

The communication apparatus 72 may be configured to implement a network connection or a mobile data connection between devices.

The display terminal provided in this embodiment may be used to perform the information display method for a social application provided in any one of the foregoing embodiments, and has corresponding functions.

Embodiment 7

Embodiment 7 of the present application further provides a computer-readable storage medium storing at least one computer program. The at least one computer program, when run by a processor, causes the processor to perform the information display method for a social application in any one of the foregoing embodiments. The method may specifically include the following steps that can be performed in any order: displaying posts published by first objects including a user who has a friend relationship with a current user on a first information stream page; and displaying posts published by second objects including a user, in a group that the current user joins, who has a non-friend relationship with the current user on a second information stream page corresponding to the group. Wherein a portal of the second information stream page is displayed on the first information stream page in response to the posts published by the second objects being updated.

In the storage medium including computer-executable instructions according to this embodiment of the present application, in addition to performing the foregoing method operations, the computer executable instructions can also be used to perform related operations in the information display method for a social application according to any embodiment of the present application.

Through the foregoing description of the implementations, those skilled in the art can understand that the present application can be implemented by software and general-purpose hardware, and of course, can alternatively be implemented by hardware. Based on such an understanding, the technical solutions of the present application can be embodied in the form of a software product. The computer software product may be stored in a computer-readable storage medium, such as a floppy disk, a read-only memory (ROM), a RAM, a flash memory, a hard disk, or an optical disc of a computer, and include a plurality of instructions to enable a computer device (which may be a personal computer, server, network device, or the like) to perform the method described in a plurality of embodiments of the present application.

1. An information display apparatus for a social application, comprising a first information stream page and a second information stream page, wherein the first information stream page is configured to display posts published by first objects, the first objects comprising a user who has a first-type relationship with a current user, the second information stream page is configured to display posts published by second objects, the second objects comprising a user who is in a group that the current user joins and has a second-type relationship with the current user, and a portal of the second information stream page is displayed on the first information stream page in response to the posts published by the second objects being updated; and
wherein the first-type relationship is a friend relationship, and the second-type relationship is a non-friend relationship.

2. (canceled)

3. The information display apparatus according to claim 1, wherein there is at least one of:
the posts published by the first objects further comprising at least one of a post published by a user who has the second-type relationship with the current user and pushed by a backend of the social application or an advertisement pushed by the backend of the social application; or the posts published by the second objects further comprising an advertisement related to the group that the current user joins and pushed by the backend of the social application.

4. The information display apparatus according to claim 3, wherein with respect to the post published by the user who has the second-type relationship with the current user and pushed by the backend of the social application, the user who has the second-type relationship with the current user is not the user who is in the group that the current user joins and has the second-type relationship with the current user.

5. The information display apparatus according to claim 1, wherein at least one of a like control or a comment control is configured for the posts displayed on the first information stream page and the second information stream page.

6. The information display apparatus according to claim 5, wherein
likes are visible to the current user in the case that the like control is configured for the posts displayed on the first information stream page and the second information stream page;
comments are visible to the current user in the case that the comment control is configured for the posts displayed on the first information stream page and the second information stream page; or
likes and comments are visible to the current user in the case that the like control and the comment control are configured for the posts displayed on the first information stream page and the second information stream page.

7. The information display apparatus according to claim 1, wherein the portal of the second information stream page is displayed on the first information stream page in a form of a post group bar, wherein the post group bar and the posts on the first information stream page are sequentially arranged on the first information stream page based on post publishing time.

8. The information display apparatus according to claim 1, wherein the portal of the second information stream page is displayed on the first information stream page in a form of a post group bar, wherein at least one of a name of the group, an image of the group, or status information of the group is displayed in the post group bar.

9. The information display apparatus according to claim 1, wherein a portal for the current user to add the user as a friend is configured for the post published by the user who has the second-type relationship with the current user and displayed on the second information stream page.

10. The information display apparatus according to claim 9, wherein in the case that the current user adds the user who is in the group that the current user joins and has the second-type relationship with the current user as the friend, a post published by the user added by the current user as the friend is removed from the second information stream page and displayed on the first information stream page.

11. An information display method for a social application, comprising the following steps that can be performed in any order:
displaying posts published by first objects on a first information stream page, wherein the first objects comprise a user who has a friend relationship with a current user; and
displaying posts published by second objects on a second information stream page corresponding to a group that the current user joins, wherein the second objects comprise a user who is in the group that the current user joins and has a non-friend relationship with the current user; wherein
a portal of the second information stream page is displayed on the first information stream page in response to the posts published by the second objects being updated.

12. The information display method according to claim 11, further comprising at least one of:
displaying, on the first information stream page, at least one of a post published by a user who has the non-friend relationship with the current user and pushed by a backend of the social application or an advertisement pushed by the backend of the social application; or
displaying, on the second information stream page corresponding to the group that the current user joins, an advertisement related to the group that the current user joins and pushed by the backend of the social application.

13. The information display method according to claim 11, further comprising:
in the case that the current user adds the user who is in the group that the current user joins and has the non-friend relationship with the current user as a friend, removing a post published by the user added by the current user as the friend from the second information stream page and displaying the post on the first information stream page.

14. The information display method according to claim 13, further comprising:
performing a corresponding friend adding operation based on the post published by the user who is in the group that the current user joins and has the non-friend relationship with the current user and displayed on the second information stream page corresponding to the group; wherein a portal for the current user to add the user as the friend is configured for the post published by the user who has the non-friend relationship with the current user.

15. The information display method according to claim 11, wherein the displaying the posts published by the second objects on the second information stream page corresponding to the group that the current user joins comprises:
determining a target group that the current user and the user who has the non-friend relationship with the current user both join; and
displaying the post published by the user who has the non-friend relationship with the current user on the second information stream page corresponding to the target group.

16. The information display method according to claim 15, wherein the determining the target group that the current user and the user who has the non-friend relationship with the current user both join comprises:
determining one or more groups that the current user and the user who has the non-friend relationship with the current user both join; and
in the case that the number of groups is one, determining the group as the target group; or
in the case that the number of groups is more than one, determining a group with a highest degree of interaction between the current user and the user who has the non-friend relationship with the current user in a plurality of groups as the target group.

17. A display terminal, comprising:
at least one processor; and
a storage apparatus, configured to store at least one program;
wherein the at least one processor, when running the at least one program, is caused to perform:
displaying posts published by first objects on a first information stream page, wherein the first objects comprise a user who has a friend relationship with a current user; and
displaying posts published by second objects on a second information stream page corresponding to a group that the current user loins, wherein the second objects comprise a user who is in the group that the current user joins and has a non-friend relationship with the current user; wherein a portal of the second information stream page is displayed on the first information stream page in response to the posts published by the second objects being updated.

18. An information display system, comprising a publishing terminal, a server, and the display terminal according to claim 17; wherein
the publishing terminal is configured to upload corresponding published posts to the server; and the server is configured to find a user who has a friend relationship with a publishing user corresponding to the published post and a user, in a group that the publishing user joins, who has a non-friend relationship with the publishing user, and send the published post and a relationship between a display user of the display terminal and the publishing user to the display terminal of the user who has the friend relationship with the publishing user and the display terminal of the user who has the non-friend relationship with the publishing user.

19. The system according to claim 18, wherein the server is configured to find the user who has the friend relationship with the publishing user corresponding to the published post and the user, in a group that the publishing user joins, who has the non-friend relationship with the publishing user in the following manner: determining the user who has the friend relationship with the publishing user in a friend database of the publishing user, selecting the group that the publishing user joins in a group database of the publishing user, and determining the user, in the group that the publishing user joins, who has the non-friend relationship with the publishing user.

20. The system according to claim 18, wherein the server is further configured to actively push at least one of a post published by a user who has the non-friend relationship with the display user of the display terminal or a corresponding advertisement to the display terminal.

21. A non-transitory computer-readable storage medium, storing at least one computer program, wherein the at least one computer program, when run by a processor, causes the processor to perform the information display method for the social application as defined in claim 11.
